(19) United States
(12) Patent Application Publication
(10) Pub. No.: US 2006/0019749 A1
(43) Pub. Date: Jan. 26, 2006

(54) Secure server-based gaming platform

(75) Inventors: Bruce Merati, San Diego, CA (US); Roberto Edwards, San Diego, CA (US)

Correspondence Address: HOGAN & HARTSON L.L.P., 500 S. GRAND AVENUE, SUITE 1900, LOS ANGELES, CA, 90071-2611, US

(73) Assignee: Virtgame Corp.

(21) Appl. No.: 11/165,389

(22) Filed: Jun. 23, 2005

Related U.S. Application Data
(60) Provisional application No. 60/585,206, filed on Jul. 1, 2004.

(51) Int. Cl. G06F 17/00

(52) U.S. Cl. 463/42

(57) ABSTRACT

A secure gaming system or platform. Client monitors accept user input and displaying game status and outcomes. No game processing or decisions occur at the client monitors. A game server is coupled to and remote from the client monitors, and comprises a processor for executing game programs based on user input supplied by the client monitor. The game server returns game outcomes to the client monitor for display. All game processing and intelligence takes place at the game server. A database logs all game outcomes, events and user input as provided by the game server. An audit server replays all games executed by the game server based on the events and user input provided by the game server, and compares the results with the database logs and game outcomes independently supplied to the audit server by the client monitor to verify and ensure the integrity of gaming activity.

### CROSS-REFERENCE TO RELATED APPLICATIONS

This application claims the benefit of U.S. provisional application No. 60/585,206, filed Jul. 1, 2004, which is hereby incorporated herein by reference.

### FIELD OF THE INVENTION

The present invention relates to electronic gaming devices and, in particular, relates to a secure server-based gaming platform.

### BACKGROUND OF THE INVENTION

Gaming is becoming an increasingly popular form of entertainment. Gaming and wagering activities are typically tightly controlled and regulated by authorities such as state or county gaming boards or commissions, etc. Players making wagers on games of chance expect outcomes to be completely random and free from any tampering or unfair influence. For these reasons, it is imperative that gaming operations and stations be completely secure and free from possibility of tampering, modification, or influence on game outcomes.

### SUMMARY OF THE INVENTION

The present invention provides a secure server-based gaming platform that ensures the integrity and security of a client-server based gaming system. Importantly, the platform provides: (1) real-time auditing of game play; (2) real-time monitoring of system integrity; and (3) a remote event system that provides real-time notification of all events originating on a client platform to a game server.

One embodiment of the invention is a secure gaming system or platform. The system comprises at least one client monitor for accepting user input and displaying game status and outcomes. No game processing or decisions occur at the client monitor. A game server is coupled to and remote from the client monitor, and comprises a processor for executing game programs based on user input supplied by the client monitor. The game server returns game outcomes to the client monitor for display. A database logs all game outcomes, events and user input as provided by the game server. An audit server replays all games executed by the game server based on the events and user input provided by the game server, and compares the results with the database logs and game outcomes independently supplied to the audit server by the client monitor to verify and ensure the integrity of gaming activity.

Other systems, methods, features and advantages of the invention will be or will become apparent to one with skill in the art upon examination of the following figures and detailed description. It is intended that all such additional systems, methods, features and advantages be included within the description, be within the scope of the invention and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating a system according to the present invention.

### DETAILED DESCRIPTION OF THE INVENTION

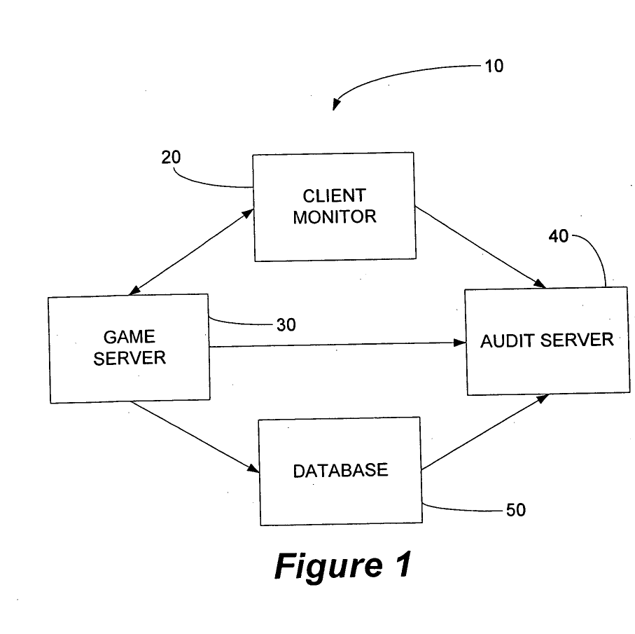

A secure server-based gaming platform or system 10 is illustrated in FIG. 1. System 10 includes a plurality of client monitors 20 (one shown), a game server 30, an audit server 40 and a database 50.

At least one client monitor 20, and typically a plurality of client monitors 20, is connected to a central game server 30. In one embodiment, client monitors 20 are dispersed throughout a casino gaming area and connected to a game server 30, which is located in a secure location accessible only to authorized personnel. Client monitors 20 may be dispersed, for example, in a manner similar to the placement of slot machines, video poker and other gaming stations throughout a casino.

Each client monitor 20 is a generic “dumb” terminal and makes no gaming decisions, calculations or actions. Instead, all gaming decisions, calculations and actions are made or taken by game server 30. The gaming software is stored and run on game server 30, while client monitors 20 simply display the on-going visual and audio aspects of the games to a player, and accepts input from the player in the form of gaming choices or decisions. Client monitors 20, via game server 30, may present any desired game or contest of skill or chance to players.

Typical casino games that may be presented by client monitor 20 (via game server 30) may include, for example, slots, poker, blackjack and other card games, roulette, craps, baccarat and so on. One of the advantages of the present invention is that the particular game presented by a client monitor 20 may be changed simply by provision of a new game by game server 30 to client monitor 20. There is no requirement that a physical change or replacement be made to the client monitor 20, as is the case with independent slot machines, for example. In one embodiment, a player may be presented with a plurality of game choices. That is, a player may choose to play blackjack, slots, poker or any other game from a single client monitor by making an appropriate choice of game. Once the player makes his choice of game, that input is provided to game server 30, which then runs the corresponding game software and provides the appropriate audio and video data to client monitor 20.

Typically, a player will place bets or wagers on the game being played, resulting in winnings or losses depending on the outcome of the game. As such, client monitors 20 also include appropriate hardware for accepting and dispersing funds to players. Client monitor 20 may include, for example, a slot for accepting coins, chips or tokens, a bill acceptor, a card reader or any other mechanism for accepting funds from a player. Client monitor 20 may also include means for physically (i.e coin/token/ticket/bill dispensers) or electronically transmitting funds to players. Client monitor 20 may also have an appropriate reader or interface permitting presentation of a players' club card or the like, containing personal information about the player and permitting game server 30 to track players' performance and play.

Client monitor 20 monitors all gaming actions and forwards those actions to game server 30 and audit server 40. Monitor 20 will typically include a display of some sort to display gaming activity and events, fund balances, etc., to the user. The display may be a cathode ray tube (CRT), liquid crystal display (LCD) or any other appropriate means for display. Monitor 20 also preferably includes speakers for gaming audio. Monitor 20 also includes some form of user interface to allow the user to provide input to system 10. The user interface may include, without limitation, buttons or keys, sensors, touch sensitive screens, cursor control devices such as a mouse, joysticks and so on. Monitor 20 may also include other components such as a printer for providing printouts of gaming activity, fund levels, etc.

In one implementation, monitor 20 utilizes a browser to display the content of game server 30. In one implementation, monitor 20 also comprises a proxy server for relaying user input to game server 30, receiving responses from game server 30, and reflecting or mirroring those response to audit server 40 (as will be described in more detail below).

Again, and importantly, no decisions, game processing or actions take place at client monitor 20. Client monitor 20 simply accepts input from players, relays that input to game server 30. Game server 30 receives the input from client monitor 20, provides the input to the processor running the gaming software, and transmits the result (i.e., the outcome of the game and wager) to client monitor 20. Client monitor 20 then displays the game and wager outcome to the player. This is extremely important from a security and regulation perspective. Gaming and wagering activities are typically tightly controlled and regulated by authorities such as state or county gaming boards or commissions, etc. As such, casino and gaming operators must show that games are not susceptible to manipulation or tampering by players or other persons. Removal of all game processing and game software from client monitor 20, and placement of all processing and decision activity in a central, secure and inaccessible gaming server, provides a very high level of protection against any manipulation or tampering of game processes and outcomes.

All gaming software resides on game server 30, and all gaming decisions and processing are made at game server 30. Game server 30 is securely linked to each client monitor 20 under its control, receives gaming input and request from those monitors, and provides the correct output or result to the client monitors in response. Game server 30 includes appropriate hardware and software for running various games of chance as described above.

Game server 30 may take various forms, such as a mainframe computer, a personal computer or workstation, a laptop computer and so on. Game server 30 will typically include a processor that controls operation of server 30, and calculates gaming outcomes based on input provided by client monitors 20. The processor may be any suitable central processing unit, general or special purpose microprocessor or digital signal processor. Server 30 will also include a memory coupled to the processor and containing the various game programs, as well as operational software for the server. The memory may comprise, for example, non-volatile memory devices such as, for example, EPROM (Erasable Programmable Read Only Memory), EEPROM (Electrically Erasable Programmable Read Only Memory), Flash memory, NVRAM (Non-Volatile Random Access Memory, internal and/or removable disks, CD-ROM or DVD-ROM disks, as well as volatile memory devices such as RAM or DRAM. Server 30 will also include appropriate displays and user interfaces to facilitate operation by authorized personnel.

Game server 30 also hosts a separate and continuously running random number generator (RNG) for each client monitor 20 that server 30 is associated with. The RNG for each client monitor 20 is used, in conjunction with the gaming input from the player, to generate the outcome of the game being played by the player. Hence, the outcome of each client monitor 20 is in no way related to the outcomes of other client monitors. Each client monitor has its own RNG, residing on game server 30. The provision of individual RNGs for each client monitor, all residing on a central server, is another important and novel aspect of the present invention. RNG is addressed in more detail in commonly-owned and co-pending application No. ______, filed on even date herewith and claiming the benefit of U.S. provisional application Ser. No. 60/585,176, which is hereby incorporated herein by reference.

All gaming events, outcomes, user decisions and inputs are provided to and logged by database 50. Audit server 40 provides real-time auditing of game play by double-checking and re-playing all games played. User input and actions, as well as the RNG seed, are provided to audit server 40 by game server 30. Audit server 40 uses this information to verify the random numbers generated by server 30, plays the games and compares the results with the log stored in database 50 to ensure that the outcome is what it should be. Client monitor 20 also mirrors the game outcomes returned to it by game server 30 to audit server 40, so that audit server 40 can verify that the proper outcomes are, in fact, being returned by game server 30 to client monitor 20.

Game server 30 and audit server 40 constantly monitor system integrity using appropriate monitoring and change detection software. There is a constant monitoring of, for example, registry settings, hardware configuration parameters, system files, directories, data files, file attributes and the like to ensure that the gaming platform is not modified or tampered with by anyone not having authorized access to the system. Any unauthorized access, changes, intrusions, corruptions, installations, removal or revisions to software, and so on, are instantly detected and notified. In one implementation, INTACT™ software from Pedestal Software, Inc. is deployed in game server 30 and audit server 40 to monitor system integrity.

Game server 30 constantly monitors system parameters and integrity of audit server 40 and client monitors 20. Audit server 40, in turn, constantly monitors the integrity of game server 30 and client monitors 20. Hence, each of the servers is constantly watching the other server, as well as the client monitors. This provides an extremely high level of security and ensures that any compromises of system integrity will be instantly detected.

Another aspect of the invention, as previously mentioned, is a real-time, remote event system that allows for notification of all events originating on client monitors 20 to game server 30. All processing intelligence is thereby removed from client monitors 20 and centralized in game server 30.

Another level of system security and integrity is provided by the use of “heartbeats” between system components. A heartbeat is a periodic signal sent by components of system 10 to signify that they are still active and reliable. A lack of a heartbeat within the specified interval (i.e. once a second, or whatever the interval is specified to be) signals that some form of failure or corruption of the device that failed to send the heartbeat. Hence, game server 30 and audit server 40 exchange heartbeats. If one is take over or corrupted in some way, the other will instantly know. Game server 30 and client monitors 20 exchange heartbeats. If game server 30 becomes unreliable, client monitors 20 will instantly know. If any of client monitors 20 is taken over or off line, game server 30 will instantly know. Client monitors 20 also provide a heartbeat to audit server 40, allowing audit server 40 to be instantly informed of any failure on the part of any of client monitors 20.

While various embodiments of the invention have been described, it will be apparent to those of ordinary skill in the art that many more embodiments and implementations are possible that are within the scope of this invention.

1. A secure gaming system comprising:
at least one client monitor for accepting user input and displaying game status and outcomes, wherein no game processing or decisions occur at the client monitor;
a game server coupled to and remote from the client monitor, the game server comprising a processor for executing game programs based on user input supplied by the client monitor, the game server returning game outcomes to the client monitor for display;
a database that logs all game outcomes, events and user input as provided by the game server; and
an audit server that replays all games executed by the game server based on the events and user input provided by the game server, and compares the results with the database logs and game outcomes independently supplied to the audit server by the client monitor to verify and ensure the integrity of gaming activity.

2. A secure gaming system as claimed in claim 1, wherein a separate RNG for each client monitor resides on the game server.

3. A secure gaming system as claimed in claim 1, and further comprising software for constantly monitoring system integrity, residing on the game server and audit server.

4. A secure gaming system as claimed in claim 1, wherein multiple game programs are stored on the game server, and are selected and executed based on the user input.

5. A secure gaming system as claimed in claim 1, wherein the client monitor comprises a web browser for displaying content from the game server.

6. A secure gaming system as claimed in claim 5, wherein the client monitor further comprises a proxy server for relaying the user input to the game server, for receiving responses from the game server, and for mirroring the responses to the audit server.

7. A secure gaming system as claimed in claim 1, wherein the audit server and the game server exchange heartbeats, wherein the client monitor and game server exchange heartbeats, and wherein the client monitor provides a heartbeat to the audit server.
